(19) United States
(12) Patent Application Publication
(10) Pub. No.: US 2008/0074009 A1
(43) Pub. Date: Mar. 27, 2008

(54) FAN SYSTEM, ELECTRIC MOTOR, AND CLAW-POLE MOTOR

(76) Inventors: YUJI ENOMOTO, Hitachi (JP); Hisato Amano, Hitachi (JP); Motoya Ito, Hitachinaka (JP); Shigeki Morinaga, Yachiyo (JP); Ryoso Masaki, Hitachi (JP); Kazuhide Ebine, Narashino (JP); Yuji Toyama, Iwafune (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/844,375

(22) Filed: Aug. 24, 2007

(30) Foreign Application Priority Data
Sep. 25, 2006 (JP) 2006-258224

(51) Int. Cl. H02K 7/14; H02K 1/12; H02K 1/27

(52) U.S. Cl. 310/67 R; 310/257

(57) ABSTRACT

A fan system having a three-phase claw-pole motor comprising a stator and a rotor, wherein the three-phase claw-pole motor provides with stator coils for three phases which are arranged on one plane.

### CLAIM OF PRIORITY

The present application claims priority from Japanese application serial No. 2006-258224, filed on Sep. 25, 2006, the content of which is hereby incorporated by reference into this application.

### BACKGROUND OF THE INVENTION

1. Field of the Invention

The present invention relates to a motor-driven fan system such as an exhaust fan, a ventilating fan, an air fan, and a cooling fan. The invention also relates to an electric motor and a claw-pole motor.

2. Prior Art

In general, fan systems are used for cooling an apparatus and sending air. Because fan systems for many purposes are kept rotating, they are required to be high efficient and small, and to generate less vibrations and less noises. In general, fan systems are driven by motors. Various drive motors are used for different purposes. Each of these motors is a slot-tooth motor. The stator core of a slot-tooth motor includes a laminated electromagnetic steel plate wound with windings. The fan motors may be motors as disclosed in JP-2001-231192A and JP-H6-78486A. Each of the fan motors includes a stator core, coils referred to as coil ends, a pair of bearings, and a pair of end brackets. The coils are positioned on both sides of the stator core. The bearings are positioned out of contact with the coils. Each of the end brackets holds one of the bearings on one side of the stator core.

Techniques for reducing the vibration and noise of a motor are disclosed in JP-H8-70550A, JP-H6-30549A, and JP-H8-298740A. Each of these techniques makes it possible to reduce the vibration and noise of the whole motor by improving part accuracy and assembly accuracy such as the accuracy in assembling a stator and bearings and the accuracy in assembling a shaft and a rotor, and by inhibiting the generation of vibrations due to shaft runout which would be caused by part errors and assembly errors.

In order for a motor to be thin, it is preferable that no coil end should exist axially of the motor. Such a thin motor may be a two-phase claw-pole motor as disclosed in Japanese Patent No. 3,246,724.

Patent Document 1: Japanese Application Patent Laid-open Publication No. JP2001-231192A

Patent Document 2: Japanese Application Patent Laid-open Publication No. JP-H6-78486A

Patent Document 3: Japanese Application Patent Laid-open Publication No. JP-H8-70550A

Patent Document 4: Japanese Application Patent Laid-open Publication No. JP-H6-30549A

Patent Document 5: Japanese Application Patent Laid-open Publication No. JP-H8-298740A

Patent Document 6: Japanese Patent No. 3,246,724

### SUMMARY OF THE INVENTION

In each of the Patent Documents 1 to 5 (JP-2001-231192A, JP-H6-78486A, JP-H8-70550A, JP-H6-30549A, and JP-H8-298740A), the axial dimension of the fan system depends on the axial dimension of the motor, which includes a stator core, coil ends, and end brackets. The coil ends and the end brackets are positioned on both sides of the stator core. The constitution of the motor limits the thinning of the fan system.

With regard to vibration and noise, the part connecting the rotor shaft and the blades together is thin, so that the blades may incline with respect to the rotor shaft. It is difficult to improve the accuracy in positioning the blades angularly with respect to the rotor shaft.

The claw-pole motor disclosed in the Patent Document 6 (Japanese Patent No. 3,246,724), in which no coil end exists, has a two-phase structure, which causes great torque pulsation, so that the motor vibrates greatly. The output torque of this motor cannot be large because of the thickness of its core plates and the deterioration of the magnetic characteristics of the plates themselves. This makes it impossible to construct a desired fan system. One of the causes for this is that the residual magnetic flux density of the magnets of the motor cannot be high because the stator core of the motor is formed by bending the core plates. The other cause is that the eddy current flowing through the core plates worsens their magnetic characteristics and increases the loss of the characteristics.

In each of these motors, the stator coils generate magnetic fields, which generate eddy current. The current generation causes current to flow from the bearing holder of the rotor out through the bearings. This may cause electric erosion.

The object of the present invention is to provide a thin fan system including a fan motor and/or an electric motor having an axial dimension only for the parts of the motor which contribute to torque creation, the system being efficient, designed to generate less vibrations and less noises, and free from electric erosion.

A fan system according to the present invention having a three-phase claw-pole motor is comprising a stator and a rotor, wherein the three-phase claw-pole motor provides with stator coils for three phases which are arranged on one plane.

According to the present invention, the fan system and the motor are thin, generate less vibration and less noise, and are free from electric erosion can be achieved.

### BRIEF DESCRIPTION OF THE DRAWINGS

FIG. 1 is an axial section of a fan system in the embodiment of the present invention.

FIG. 2 is a radial section of the fan system in the embodiment of the present invention.

FIG. 3 is an exploded view of the fan system in the embodiment of the present invention.

FIG. 4 shows a motor structure in the embodiment of the present invention and having two coils for each phase.

FIGS. 5A and 5b show other motor structures in the embodiment of the present invention and having different magnet shapes.

FIG. 6 shows a conventional fan system structure.

FIG. 7 shows the relationship between the axial dimensions of the fan system in the embodiment of the present invention and the conventional fan system.

FIG. 8 is an axial section of a thin fan system including a two-color molded fan in the another embodiment of the present invention.

### DETAILED DESCRIPTION OF THE INVENTION

Preferred embodiments of the present invention will be described below with reference to the accompanying drawings.

### Embodiment 1

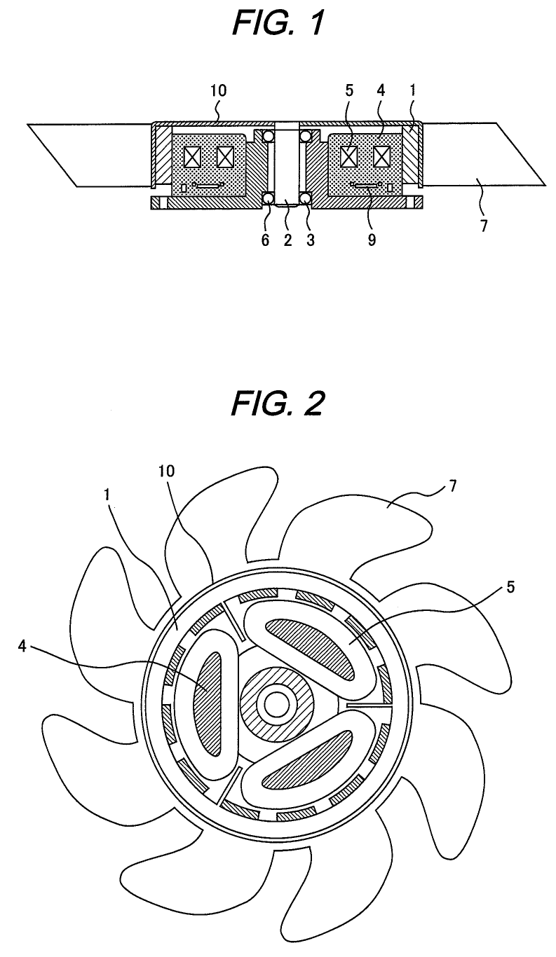

FIG. 1 is an axial section of a thin fan system in the embodiment of the present invention. The fan system includes an outside rotating claw-pole motor as a motive power source and blades 7 which is provided outside of the rotor yoke 10 of the rotor. In the claw-pole motor, the stator coils 5 is accommodated inside of the stator core 4, so that the ends of the stator coils 5 do not protrude from the stator cores 4 axially of the fan system. The stator unit consists of a stator core 4 and stator coils 5 and a control board 9, which is mounted on the stator unit insulatively with an insulating sheet or the like.

The stator consists of stator cores 4 and stator coils 5 for a plurality of phases and the stator coils 5 are arranged on one plane and fitted in the stator cores 4. The stator unit is coaxial with and perpendicular to a bracket 3, which holds bearings 6. The bearings 6 support a shaft 2, which is fixed to a rotor yoke 10. The rotor yoke 10 is surrounded by the blades 7 and holds magnets 1, which are spaced from the stator unit and rotatable around the stator unit. The blades 7 rotate with the rotor.

The zone of the fan system which contributes to torque creation and where the stator and the rotor faces each other may occupy a half or more of the axial dimension of the fan system. FIG. 2 is a radial section of the fan system. As shown in FIG. 2, the claw-pole motor has stator coils 5 for three phases, which are arranged on one plane. The end portions of the stator coils 5 are wound toward the center of the stator so as not to extend axially of the fan system. The claw-pole motor is a three-phase motor so that the torque pulsation in it can be smaller than that in a two-phase motor. The torque created by a two-phase motor consists of waves that are 90 degrees out of phase, so that the torque pulsates greatly. The torque created by a three-phase motor consists of waves which are 120 degrees out of phase, so that the torque pulsates far less than in a two-phase motor. The rotor yokes 10 of the stator cores 4 are positioned at the centers of the stator coils 5. Each of the rotor yokes 10 includes an outer arc portion and an inner linear portion. This increases the coil turns around the outer arc portion, which contribute to flux linkage, so as to reduce the coil ends. In addition, this makes it easy to keep the windings in alignment.

In this embodiment, the blades 7 are eight in number. The claw-pole motor may have 12 teeth and 14 poles. In this case, the order of the number of blades 7 might be so selected that torque ripples would not be liable to be made. This could prevent the claw-pole motor from having parts where the vibration and noise due to resonance or the like would increase at certain rotational speeds in certain load ranges.

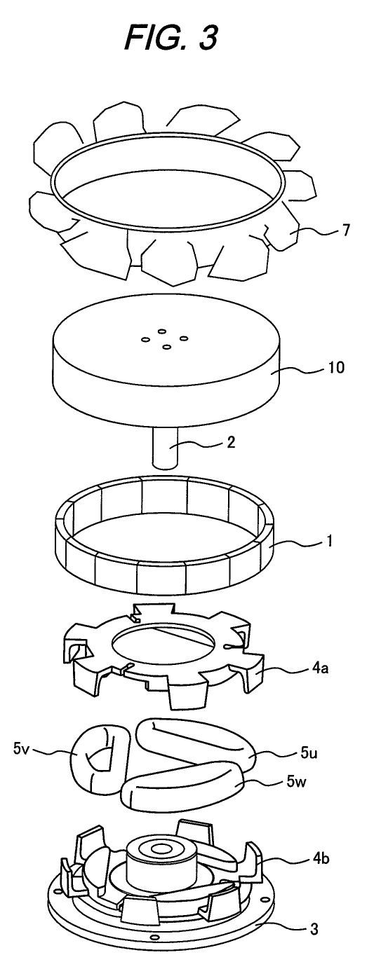

FIG. 3 is an exploded view of the fan system shown in FIG. 1. The stator cores 4 comprises an upper core 4a and a lower core 4b. The process for assembling the fan system includes the steps of placing the stator coils 5 on the bracket 3 and lower stator core 4b of the stator cores 4 and putting the upper stator core 4a of the stator cores 4 over the placed coils 5, thereby forming the stator unit. The rotor magnets 1 in the form of a ring are fixed to the rotor yoke 10 with an adhesive or the like. The stator unit supports the rotor by means of the bearings 6, which are held by a bearing holder. The blades 7 are fixed to the outer periphery of the rotor yoke 10.

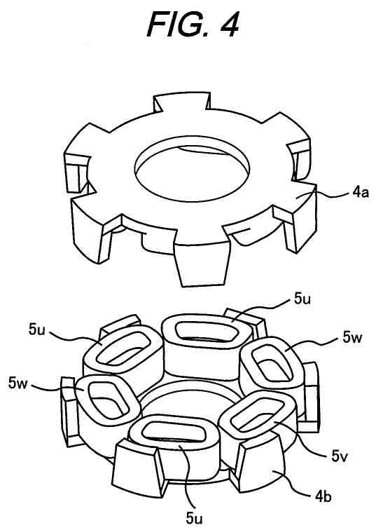

FIG. 4 shows a claw-pole motor with a modified arrangement of coils. In the claw-pole motor shown in FIGS. 1-3, in which the three stator coils 5 are arranged on one plane, torque and radial electromagnetic force are created for each phase and may accordingly generate vibrations and noises. In the claw-pole motor shown in FIG. 4, the stator coils 5 for each phase are spaced at an angle of about 180 degrees from each other. The electromagnetic forces created radially by the coils for each phase are equivalent and can therefore cancel out each other. This coil arrangement of the stator coil 5 makes it possible to reduce the vibration and noise of the claw-pole motor.

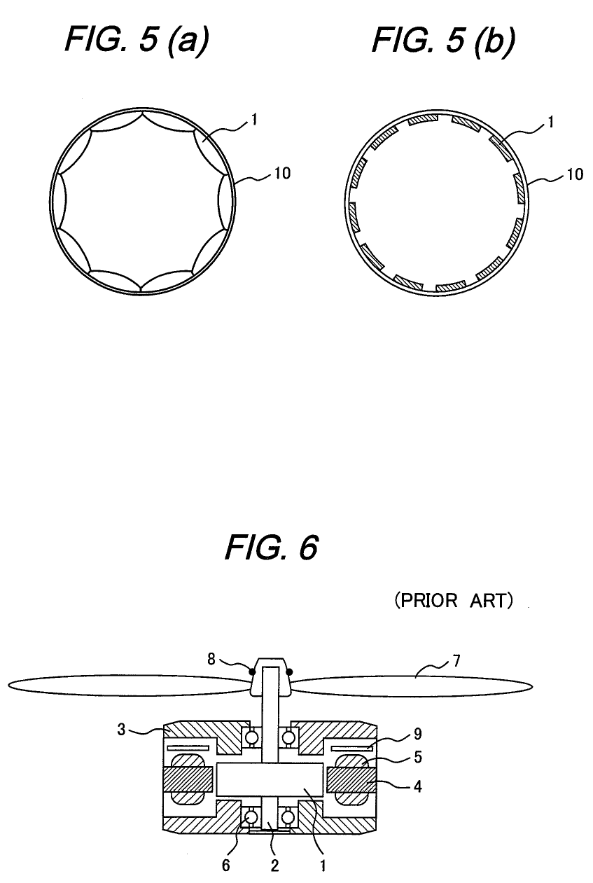

FIGS. 5A and 5B show magnet shapes of the magnet 1 in the embodiment. In the stator coils 5u, 5v and 5w of the stator coil 5 in the embodiment shown in FIG. 4, vibration and noise can be reduced, but the output torque per unit volume is low because of many coil end portions. Therefore, a motor with three stator coils 5 as shown in FIGS. 1-3 is preferable in terms of output. The vibration and noise of a claw-pole motor with three stator coils 5 can be reduced by a method of torque pulsation reduction based on magnet shape. FIG. 5A shows magnets 1 in arc shape. The gaps between the magnets 1 in arc shape alter so that the air-gap magnetic flux density distribution can smoothly alter. This makes the induced voltage sinusoidal so as to reduce vibration and noise. Even if the magnets of a two-color molded magnet motor are complex in shape, they can take such arc shape because they can be molded into magnetic pole shape with high precision. FIG. 5B shows a rotor yoke 10 and magnets 1 that are unified by the two-color molding method, with the magnets 1 arranged on the yoke 10 with high precision. This makes the pole pitch of the magnets 1 constant, thereby making it possible to reduce cogging torque and noise. Because the rotor yoke 10 and magnets 1 can be unified, the rotor can be formed of parts that are not made of soft magnetic material.

### Embodiment 2

FIG. 8 shows an axial section of a thin fan system including a two-color molded magnet rotor in the another embodiment of the present invention. Because the rotor yoke 10 and magnets 1 of this rotor are unified, the magnets 1 can be precision magnets and arranged on the fan itself, so that noise may hopefully be reduced effectively. This rotor includes a part 11 in contact with a rotor shaft 2. The part 11 is a non-conductor. This enables the fan to be a non-conductor so that no shaft current can flow through the rotor shaft 2. This makes it possible to realize a structure that prevents electric erosion (bearing failure), which would be caused by the current flowing from the rotor shaft 2 through the bearings 6 to the housing ground.

The example of the non-conductor may be a plastic. The motor shown in FIG. 8 is an outside rotating motor but might, needless to say, be an inside rotating motor for the foregoing results. The motor shown in FIG. 8 is a claw-pole motor but might, needless to say, be a conventional slot type motor for the foregoing results.

FIG. 6 shows the structure of a conventional fan system. The conventional fan motors which output several tens or more of watts are inside rotating motors. This fan system includes a stator core 4, which is a slot-tooth motor stator with windings. Each of the windings includes coil end portions on both its sides. The length of each of the coil end portions is substantially equal to the thickness (the axial length) of the stator core 4. One of the coil end portions is connected to an end of a coil. A control board 9 is positioned at a creepage distance from this coil end portion. A bracket 3 with a bearing holder is positioned at a creepage distance from the control board 9. This fan system also includes a rotor consisting of a rotor shaft 2 and magnets 1. The rotor is supported by bearings 6. Blades 7 are connected to one end of the rotor shaft 2. This structure results in the fan system being large in axial dimension. It is apparent that the axial dimension of the whole fan system is at least three times as large as the axial dimension of its zone which contributes to torque creation and where the stator core 4 faces the magnets 1.

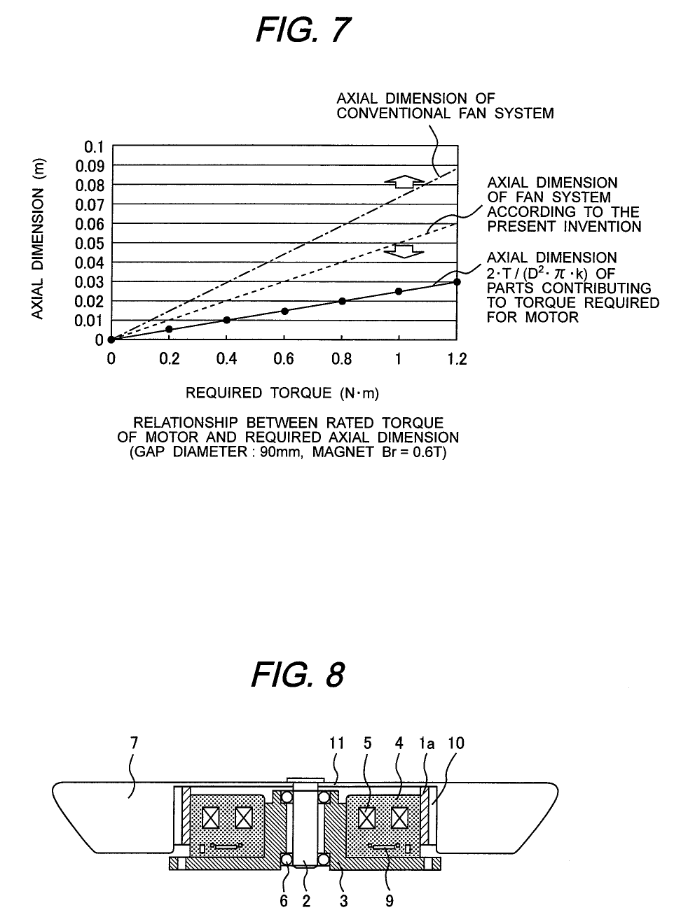

A thin fan system according to the present invention is characterized in that the axial dimension of its motor, which contributes to torque, is at least a half of the axial dimension of the whole fan system, so that the whole fan system can be thin. FIG. 7 shows the axial dimensions of fan systems for different output torques. In FIG. 7, the axis of ordinate represents the axial dimensions of the fan systems, and the axis of abscissa represents the rated torques required for the motors of the fan systems. The dimension required for a motor depends on the gap radius of the motor and the energy product (the residual magnetic flux density) of the magnets of the motor, because the torque per unit gap area of the motor is fixed to some extent. The torque per unit gap area of a motor for use as a fan motor is determined with a constant that is not set at a very high value. In the examples shown in FIG. 7, the constant k is set at 3150 N/m² on the assumption that the residual magnetic flux density of the magnets is 0.6 T. The constant k represents the force that can be exerted to the area of the zone of the fan system where the rotor and the stator faces each other with a gap made between them. The axial dimension L (m) of a motor designed with the constant k and having a gap diameter D (m) is determined from the following equation, wherein T represents the required torque.

L=2·T/(D²·p·k)

As stated already, a conventional motor needs to have coil ends and a bracket. Therefore, the axial dimension of the conventional fan system is three or more times as large as the motor dimension determined from the foregoing equation. The axial dimensions of the fan systems embodiment of the present invention can be two or less times the determined motor dimension.

Specifically, there may be a case where a motor has a gap diameter of 0.09 m, and where the residual magnetic flux density Br of the magnets of the motor is 0.6 T. In this case, as shown in FIG. 7, if the torque T required for continuous operation is set at 0.6 N·m, the required axial dimension of the motor is about 15 mm. The axial dimension of the fan system according to the present invention can be 30 mm or smaller, which is twice the required motor dimension. However, the axial dimension of the conventional fan system cannot be 45 mm or smaller. The constant k varies with the thickness of the magnets, the magnetic field orientation in the motor, etc., but it is related roughly to the residual magnetic flux density Br of the magnets. For a common motor, the constant k approximates a value higher than 5000·Br and smaller than 10000·Br (5000·Br<k<10000·Br). If the force per unit gap area is determined, the axial dimension of a fan system can be two or less times the motor dimension determined from the foregoing equation. In this case, the axial dimension LL of the fan system is expressed as following equation.

LL<4·T/(D²·p·k)

Thus, the fan system and/or the electric motor according to the present invention is thin and free from vibration and noise. Accordingly, the present invention makes it possible to reduce the space for the fan of an exhaust system, thereby making it possible to provide a small exhaust system. Because the fan system can be small so as to be fitted on a ceiling or the like, the fan system is easy to fit in a narrow space, where sufficient space can be taken up for maintenance. The present invention also makes it possible to prevent electric erosion.

The stator core of the present invention is complex in shape and would accordingly be difficult to form by the conventional core plate bending method. Therefore, it is preferable to form the stator core of the present invention by compression-molding magnetic powder. Because the magnetic powder is coated with film, it is hard for eddy current to flow in a motor the stator core of which is formed by compression-molding magnetic powder. This improves the magnetic characteristic and efficiency of the motor.

What is claimed is:

1. A fan system having a three-phase claw-pole motor comprising a stator and a rotor, wherein the three-phase claw-pole motor provides with stator coils for three phases which are arranged on one plane.

2. The fan system according to claim 1, wherein the stator and the rotor faces each other in a zone which is extending over at least a half of the axial dimension of the whole fan system.

3. The fan system according to claim 1, wherein the stator and the rotor faces each other in a zone which is extending same of the axial dimension of the motor.

4. The fan system according to claim 1, wherein the motor is an outside rotating motor, the fan system further comprising a fan fitted to the outer periphery of the rotor.

5. The fan system according to claim 1, wherein the stator and the rotor faces each other in a zone which is extending larger than the axial dimension of the coils.

6. The fan system according to claim 1, further comprising a bearing for supporting the rotor, wherein the bearing is provided in a zone in which the stator and the rotor faces each other.

7. The fan system according to claim 1, wherein the motor has a coefficient k (N/m²) representing an output per unit gap surface area, requires a torque T (N·m) for continuous drive, and has a gap diameter D (m), further comprising an axial dimension LL of the fan system has a following equation;
LL is smaller than 4·T/(D²·p·k).

8. The fan system according to claim 1, wherein a part of the rotor in contact with a rotor shaft is constructed with a non-conductor.

9. The fan system according to claim 1, wherein the rotor provides with a two-color molded magnet integrally molded of a permanent magnet and a dust core yoke.

10. The fan system according to claim 1, wherein the rotor provides with a permanent magnet which is spaced with a gap from the magnetic poles of the stator, and the permanent magnet being so shaped as to alter the gap circumferentially.

11. The fan system according to claim 1, wherein the coils for three phases are positioned at an angle of about 180 degrees from each other.

12. The fan system according to claim 1, wherein the stator provides with a yoke around which the stator coils are wound, the yoke being arc on the outside and linear on the inside.

13. An electric motor comprising a rotor, stator and a rotor shaft for supporting the rotor, wherein a portion of the rotor in contact with the rotor shaft is constructed with a non-conductor.

14. The electric motor according to claim 13, wherein the motor is constructed of a three-phase claw-pole motor, and the three-phase claw-pole motor provides with stator coils for three phases which are arranged on one plane.

15. The electric motor according to claim 13, wherein the rotor provides with a two-color molded magnet integrally molded of a permanent magnet and a dust core yoke.

16. The electric motor according to claim 14, wherein the coils for three each phases are positioned at an angle of about 180 degrees from each other.

17. The electric motor according to claim 14, wherein the stator provides with a yoke around which the stator coils are wound, the yoke being arc on the outside and linear on the inside.

18. A three-phase claw-pole motor comprising a stator, a rotor and a rotor shaft for supporting the rotor, wherein the three-phase claw-pole motor provides with stator coils for three phases which are arranged on one plane, the rotor provides with a two-color molded magnet integrally molded of a permanent magnet and a dust core yoke, and the rotor provides with a permanent magnet which is spaced with a gap from the magnetic poles of the stator, and the permanent magnet being so shaped as to alter the gap circumferentially.

19. The claw-pole motor according to claim 18, wherein the coils for three phases are positioned at an angle of about 180 degrees from each other.

20. The claw-pole motor according to claim 18, wherein the stator provides with a yoke around which the stator coils are wound, the yoke being arc on the outside and linear on the inside.
